(19) United States
(12) Patent Application Publication
(10) Pub. No.: US 2013/0200866 A1
(43) Pub. Date: Aug. 8, 2013

(54) SEMICONDUCTOR INTEGRATED CIRCUIT

(71) Applicant: Hidefumi KUSHIBE, Kanagawa (JP)

(72) Inventor: Hidefumi KUSHIBE, Kanagawa (JP)

(21) Appl. No.: 13/728,806

(22) Filed: Dec. 27, 2012

(30) Foreign Application Priority Data
Jan. 5, 2012 (JP) 2012-000723

(51) Int. Cl. G05F 1/565

(52) U.S. Cl. CPC G05F 1/565
USPC 323/275

(57) ABSTRACT

A semiconductor integrated device includes transistor between input and output terminals, an amplifying device, and a control circuit that activates or deactivates the amplifying device according to an input voltage. When the input voltage is higher than a specified value, the control circuit activates the amplifying device to regulate a monitoring voltage to a value equal to a reference voltage, and outputs a control voltage to act on the gate of the transistor. When the input voltage is lower than the specified value, the control circuit deactivates the amplifying device so that a predetermined gate voltage is applied to the gate of the transistor.

### CROSS-REFERENCE TO RELATED APPLICATION

This application is based upon and Claims the benefit of priority from Japanese Patent Application No. 2012-000723, filed Jan. 5, 2012; the entire contents of which are incorporated herein by reference.

### FIELD

Embodiments described herein relate generally to a semiconductor integrated circuit.

### BACKGROUND

Conventionally, in semiconductor integrated circuits having regulators and power switch circuits, a p-MOS transistor for the regulator and a p-MOS transistor for the power switch are connected in parallel between a power input terminal and a power output terminal.

When the regulator is under high input power voltage and the power switch is under low input power voltage, these two elements may be switched so as to be alternately operated as necessary, according to the principle of the conventional semiconductor integrated circuit.

The semiconductor integrated circuit of the type described above, however, requires a large scale power switch different from the regulator circuit. Therefore, the increase in required circuit area for the semiconductor integrated circuit of the type described above also leads to a increase in fabrication cost.

### DESCRIPTION OF THE DRAWINGS

FIG. 1 is a circuit diagram of a semiconductor integrated circuit according to a first embodiment.

FIG. 2 is a circuit diagram of a gate voltage generating circuit of the semiconductor integrated circuit of FIG. 1.

FIG. 3 is a circuit diagram of a semiconductor integrated circuit according to a second embodiment.

FIG. 4 is a circuit diagram of a semiconductor integrated circuit according to a third embodiment.

FIG. 5 is a circuit diagram of a semiconductor integrated circuit according to a fourth embodiment.

### DETAILED DESCRIPTION

Embodiments provide a semiconductor integrated circuit that may alternately operate as a series regulator or power switch according to an input power voltage.

In general, according to one embodiment, interpretations are given in the following sections with reference to the figures.

A semiconductor integrated circuit, as an embodiment, includes a main MOS transistor connected between an input power terminal to which a power voltage is applied and an output power terminal configured to output an output voltage, a gate voltage generating circuit configured to output a gate voltage of a to turn on the main MOS transistor, and an amplifying device configured to output a control voltage according to a comparison between a monitoring voltage corresponding to the output voltage and a reference voltage. When the power voltage is higher than a first specified value, the amplifying device is activated to regulate the monitoring voltage to a value equal to the reference voltage so that the control voltage is applied to a gate of the main MOS transistor. When the power voltage is lower than the first specified value, the amplifying device is deactivated so that the gate voltage is applied to the gate of the main MOS transistor.

### First Embodiment

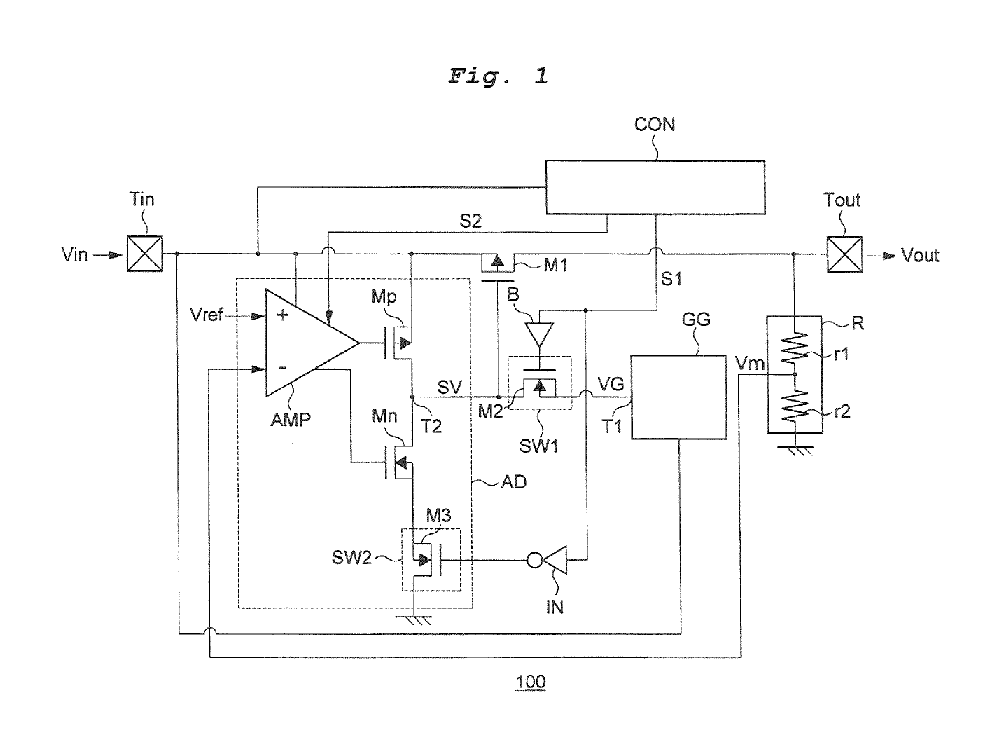

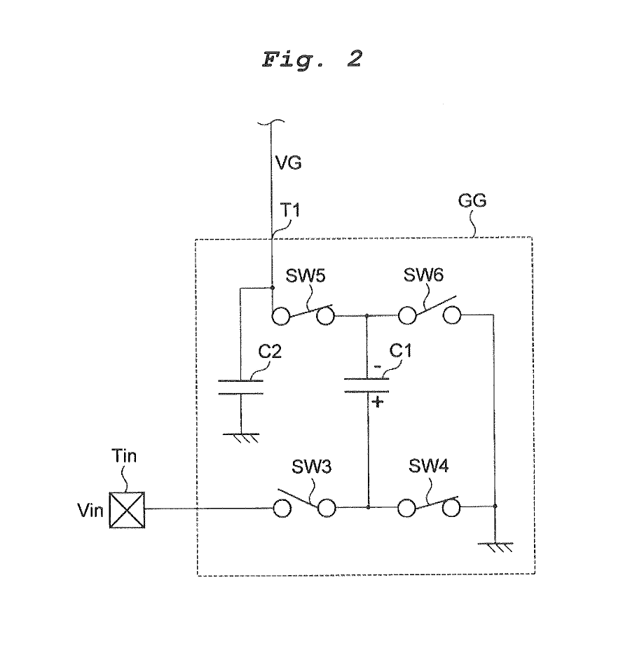

FIG. 1 is a circuit diagram of a semiconductor integrated circuit 100 according to the first embodiment. FIG. 2 is a circuit diagram of a gate voltage generating circuit GG shown in FIG. 1.

As shown in FIG. 1, the semiconductor integrated circuit 100 includes a main MOS transistor (p-MOS transistor) M1, a sub-voltage circuit R and a gate voltage generating circuit GG, a first switch element SW1, a buffer B, an inverter IN, an amplifying device AD and a control circuit CON.

For the main MOS transistor M1, an input power terminal Tin to which a power voltage Vin is applied is connected to one end (source) and a back gate, while the output power terminal Tout, which outputs an output voltage Vout, is connected to the another end (drain).

The sub-voltage circuit R is used for outputting a monitor voltage Vm (according to the output voltage Vout) which divides the output voltage Vout of output power terminal Tout.

This sub-voltage circuit R has, for example, a first sub-voltage resistor r1 and a second sub-voltage resistor r2 as shown in FIG. 1.

One end of the first sub-voltage resistor r1 is connected to the output power terminal Tout.

One end of the second sub-voltage resistor r2 is connected to another end of the first sub-voltage resistor r1 and another end of the second sub-voltage resistor r2 is grounded.

In this sub-voltage circuit R, the voltage between the one end of first sub-voltage resistor r1 and the one end of second sub-voltage resistor r2 is output as the monitoring voltage Vm.

In addition, for part of the output voltage Vout in the semiconductor integrated circuit 100, the monitoring voltage Vm (including the condition when output voltage Vout is equal to monitoring voltage Vm) will replace the sub-voltage circuit R to make up the circuit.

Moreover, the gate voltage generating circuit GG outputs from a first output terminal T1 a gate voltage VG which turns the main MOS transistor M1 on.

This gate voltage generating circuit GG outputs, for example, from the first output terminal T1, a negative gate voltage VG.

FIG. 2 shows this gate voltage generating circuit GG, including a third switch element SW3, a fourth switch element SW4, a fifth switch element SW5, a sixth switch element SW6, a first capacitor C1 and a second capacitor C2.

One end of the third switch element SW3 is connected to the input power terminal Tin.

One end of the fourth switch element SW4 is connected to another end of the third switch element SW3 and the another end of the fourth switch element SW4 is grounded.

One end of the first capacitor C1 is connected to the another end of the third switch element SW3.

One end of the fifth switch element SW5 is connected to another end of the first capacitor C1, and another end of the fifth switch element SW5 is connected to the first output terminal T1.

One end of the sixth switch element SW6 is connected to the another end of first capacitor C1, and the another end of the sixth switch element SW6 is grounded.

One end of the second capacitor C2 is grounded and the another end of the second capacitor C2 is connected to the first output terminal T1.

In the gate voltage generating circuit GG, for example, the third and the sixth switch elements SW3 and SW6 turn on and off synchronously and the operation repeats. In addition, the fourth and fifth switch elements SW4 and SW5 turn on and off synchronously and the operation repeats, so that the third switch element SW3 and the fourth switch element SW4 turn on and off complementary. By doing this, the gate voltage generating circuit GG outputs the negative gate voltage VG from the first output terminal T1.

Moreover, as shown in FIG. 1, the first switch element SW1 is connected between the gate of the main MOS transistor M1 and the first output terminal T1 of gate voltage generating circuit GG.

Therefore, the first switch element SW1 as shown in this case is a first switch n-MOS transistor M2 where the drain is connected to a second output terminal T2 while the source and the back gate is connected to the first output terminal T1.

The amplifying device AD, by comparing the monitoring voltage Vm with a reference voltage Vref, outputs control voltage SV according to the comparison result from the second output terminal T2 connected to the gate of the main MOS transistor M1.

The amplifying device AD here includes an output p-MOS transistor Mp and an output n-MOS transistor Mn with the second switch element SW2 and an amplifying circuit AMP.

The output p-MOS transistor Mp has source and back gate connected to each other, while the input power terminal Tin is connected with the source and second output terminal T2 is connected with drain of the output p-MOS transistor Mp. Gate of the output p-MOS transistor Mp is connected to a signal output from the amplifying circuit AMP, and consequently, the output p-MOS transistor Mp is controlled via the signal output from the amplifying circuit AMP.

The output n-MOS transistor Mn has source and back gate connected to each other, while the second output terminal T2 is connected with drain of the output n-MOS transistor Mn. Gate of the output p-MOS transistor Mp is connected to a signal output from the amplifying circuit AMP, and consequently, the output n-MOS transistor Mn is controlled via the signal output from the amplifying circuit AMP.

The second switch element SW2, as shown in FIG. 1, is connected between the source of output n-MOS transistor Mn and ground. The second switch element SW2, for example, is n-MOS transistor. M3 which has drain and back gate connected to each other and source connected ground.

The amplifying circuit AMP serves the input of the reference voltage Vref and the monitoring voltage Vm.

When the status of the activation of the amplifying circuit AMP and the reference voltage Vref is higher than the monitoring voltage Vm, the amplifying circuit AMP outputs a signal to turn the output p-MOS transistor Mp off and outputs a signal to turn the output n-MOS transistor Mn on.

Alternatively, when the status of the activation of the amplifying circuit AMP and the reference voltage Vref is lower than the monitoring voltage Vm, the amplifying circuit AMP outputs a signal to turn the output p-MOS transistor Mp on and outputs a signal to turn the output n-MOS transistor Mn off.

Moreover, inactive status of the amplifying circuit AMP is such that the amplifying circuit AMP outputs a signal to turn both output p-MOS transistor Mp and output n-MOS transistor Mn off.

Moreover, there should be no current flow between the output p-MOS transistor Mp and the output n-MOS transistor Mn. Accordingly the amplifying circuit AMP outputs control signals to the output p-MOS transistor Mp and the output n-MOS transistor Mn.

The control circuit CON responds to the power voltage Vin, sending control signals S1 and S2, for controlling operation of the first switch element SW1 and the amplifying device AD.

The control circuit CON outputs the control signal S1 as input to the control terminal of the first switch element SW1 (gate) via the buffer B while inputting to the control terminal of the second switch element SW2 (gate) via the inverter IN.

That is to say, the control circuit CON achieves its control function with the assistance of the first switch element SW1 and the second switch element SW2 such that the switches SW1 and SW2 turn on and off complementary.

Moreover, according to the control signals S1 and S2 sent from the control circuit CON, the active and inactive statuses of the amplifying device AD are attained alternately.

When the power voltage Vin is higher than the first specified value (1.8 V, for example), the control circuit CON activates the amplifying device AD into active status according to control signals S1 and S2. In other words, when the power voltage Vin is higher than the first specified value, the control circuit CON turns the second switch element SW2 on via the control signal S1, and the control signal S2 activates the amplifying circuit AMP.

Therefore, when the power voltage Vin is higher than the first specified value, in order that the reference voltage Vref and monitoring voltage Vm becomes equal, the amplifying device AD outputs the control voltage SV which controls the operation of the main MOS transistor M1 from the second output terminal T2 to the gate of main MOS transistor M1.

In addition, when the power voltage Vin is higher than the first specified value, the control circuit CON turns the first switch element SW1 off according to the control signal S1. In this way, the first output terminal T1 of the gate voltage generating circuit GG and the gate of the main MOS transistor M1 become insulated.

Therefore, when the power voltage Vin is higher than the first specified value, the control circuit CON causes the semiconductor integrated circuit 100 to function as a series regulator to complete the control.

On the other hand, when the power voltage Vin is lower than the first specified value, the control circuit CON deactivates the amplifying device AD according to the control signals S1 and S2. That is to say, when the power voltage Vin is lower than the first specified value, the control circuit CON controls such that the second switch element SW2 turns off via the control signal S1 while the amplifying circuit AMP becomes inactive via control signal S2.

Therefore, when the power voltage Vin is lower than the first specified value, the amplifying device AD causes the second output terminal T2 to have a higher impedance.

In addition, when the power voltage Vin is lower than the first specified value, the first switch element SW1 turns on by control circuit CON via the control signal S1 and, subsequently, the first output terminal T1 of the gate voltage generating circuit GG and the gate of the main MOS transistor M1 are in a connected state. That means, the control circuit CON provides the gate voltage VG output from the gate voltage generating circuit GG for the gate of the main MOS transistor M1. In this way, the main MOS transistor M1 turns on.

Therefore, when the power voltage Vin is lower than the first specified value, the control circuit CON causes the semiconductor integrated circuit 100 to function as a power switch.

As described above, the gate voltage VG output from gate voltage generating circuit GG is negative voltage. So when the semiconductor integrated circuit 100 functions as a power switch, the resistance value of the main MOS transistor M1 reduces because the gate voltage VG provides for the gate of the main MOS transistor M1. That means the miniaturization of the main MOS transistor M1 can be realized and the circuit area can be reduced.

In this way, the control circuit CON in the semiconductor integrated circuit 100 monitors the input power voltage Vin and the output voltage Vout, so the semiconductor integrated circuit 100 fixes automatically to function as the regulator or the power switch. Therefore, it's very easy to use the semiconductor integrated circuit 100 systematically.

In addition, it is also practical to design the control circuit CON to be outside the semiconductor integrated circuit 100.

In addition, the semiconductor integrated circuit 100 includes main MOS transistor M1 and can function alternately as the series regulator or the power switch, reducing the circuit area.

As mentioned above, in the semiconductor integrated circuit according to the first embodiment, the corresponding power voltage can reduce the circuit area, and the semiconductor integrated circuit according to the first embodiment can be used as either the series regulator or the power switch.

### Second Embodiment

The first embodiment mentioned above employs a p-MOS transistor as main MOS transistors.

The second embodiment employs an n-MOS transistor as the main MOS transistor.

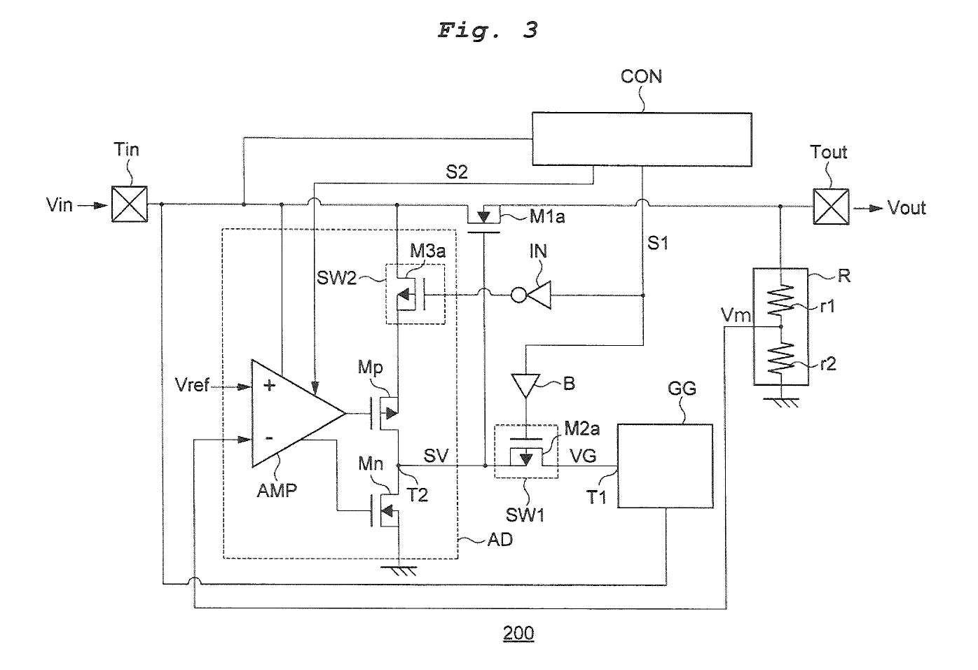

FIG. 3 is a circuit diagram of a semiconductor integrated circuit 200 according to the second embodiment. The same legend is used in FIG. 3 as in FIG. 1 to identify the same components.

As shown in FIG. 3, the semiconductor integrated circuit 200 includes a main MOS transistor (n-MOS transistor) M1a, a sub-voltage circuit R, a gate voltage generating circuit GG, a first switch element SW1, a buffer B, an inverter IN, an amplifying device AD and a control circuit CON.

Generally, the main MOS transistor M1a is an n-MOS transistor in which an input power terminal Tin is connected with a drain and an output terminal Tout is connected with a source and a back gate.

The gate voltage generating circuit GG here outputs a positive gate voltage VG from the first output terminal T1.

In addition, the first switch element SW1 is a p-MOS transistor M2a which has a source and a back gate connected to a second output terminal T2 and a drain connected to the first output terminal T1.

Moreover, the amplifying device AD here includes a second switch element SW2, an output p-MOS transistor Mp, an output n-MOS transistor Mn and an amplifying circuit AMP.

One end of the second switch element SW2 is connected to the output power terminal Tin.

The second switch element SW2 is a p-MOS transistor M3a which is connected between the input power terminal Tin and source of the output p-MOS transistor Mp and has drain and back gate connected to each other.

The output p-MOS transistor Mp has source and back gate connected to each other, while another end of the second switch element SW2 is connected with the source and the second output terminal T2 is connected with drain of the output p-MOS transistor Mp. Gate of the output p-MOS transistor Mp is connected to a signal output from the amplifying circuit AMP, consequently the output p-MOS transistor Mp is controlled via a signal output by the amplifying circuit AMP.

The output n-MOS transistor Mn has source and back gate connected to each other, while the second output terminal T2 is connected with the source and ground is connected with drain of the output n-MOS transistor Mn. Gate of the output n-MOS transistor Mn is connected to a signal output from the amplifying circuit AMP, consequently the output n-MOS transistor Mn is controlled via the signal output by the amplifying circuit AMP.

The amplifying circuit AMP serves the input of reference voltage Vref and monitoring voltage Vm.

When the status of the activation of the amplifying circuit AMP and the reference voltage Vref is higher than the monitoring voltage Vm, the amplifying circuit AMP outputs a signal to turn the output p-MOS transistor Mp on and outputs a signal to turn the output n-MOS transistor Mn off.

Alternatively, when the status of the activation of the amplifying circuit AMP and the reference voltage Vref is lower than the monitoring voltage Vm, the amplifying circuit AMP outputs a signal to turn the output p-MOS transistor Mp off and outputs a signal to turn the output n-MOS transistor Mn on.

Moreover, inactive status of the amplifying circuit AMP is such that the amplifying circuit AMP outputs a signal to turn both output p-MOS transistor Mp and output n-MOS transistor Mn off.

In addition, the other structure and function of semiconductor integrated circuit 200 according to the second embodiment are the same as that of the first embodiment.

This means that, similar to the first embodiment, when the power voltage Vin is higher than the first specified value, the control circuit CON activates the amplifying device AD according to the control signals S1 and S2. In other words, when the power voltage Vin is higher than the first specified value, the second switch element SW2 turns on by control signal S1 and the amplifying circuit AMP will be activated by control signal S2 by the control of the control circuit CON.

Therefore, when the power voltage Vin is higher than the first specified value, in order that the reference voltage Vref and the monitoring voltage Vm becomes equal, the amplifying device AD outputs the control voltage SV which controls the operation of the main MOS transistor M1a from the second output terminal T2 to the gate of the main MOS transistor M1a.

Further, when the power voltage Vin is higher than the first specified value, the first switch element SW1 turns off by the control circuit CON according to the control signal S1. Consequently the first output terminal T1 of the gate voltage generating circuit GG and the gate of the main MOS transistor M1a are insulated.

Therefore, when the power voltage Vin is higher than the first specified value, the control circuit CON causes the semiconductor integrated circuit 200 to operate as a series regulator to complete the control.

On the other hand, when the power voltage Vin is lower than the first specified value, the control circuit CON deactivates the amplifying device AD according to control signals S1 and S2. That means, when the power voltage Vin is lower than the first specified value, the second switch element SW2 turns off according to the control signal S1, and the amplifying circuit AMP becomes inactive by the control signal S2.

Therefore, when the power voltage Vin is lower than the first specified value, the amplifying device AD causes the second output terminal T2 to have a higher impedance.

Moreover, when the power voltage Vin is lower than the first specified value, the first switch element SW1 turns on via the control signal S1 from the control circuit CON and, subsequently, the first output terminal T1 of the gate voltage generating circuit GG and the gate of the main MOS transistor M1a are in a connected state. That means, the control circuit CON provides the gate voltage VG output from the gate voltage generating circuit GG for the gate of the main MOS transistor M1. Thus, the main MOS transistor M1a turns on.

Therefore, when the power voltage Vin is lower than the first specified value, the control circuit CON causes the semiconductor integrated circuit 200 to function as a power switch.

In the semiconductor integrated circuit according to the second embodiment, the corresponding power voltage can reduce the circuit area, and the semiconductor integrated circuit according to the second embodiment can be used as either a series regulator or a power switch.

### Third Embodiment

The third embodiment employs a control circuit that controls based on a potential difference between a power voltage and an output voltage.

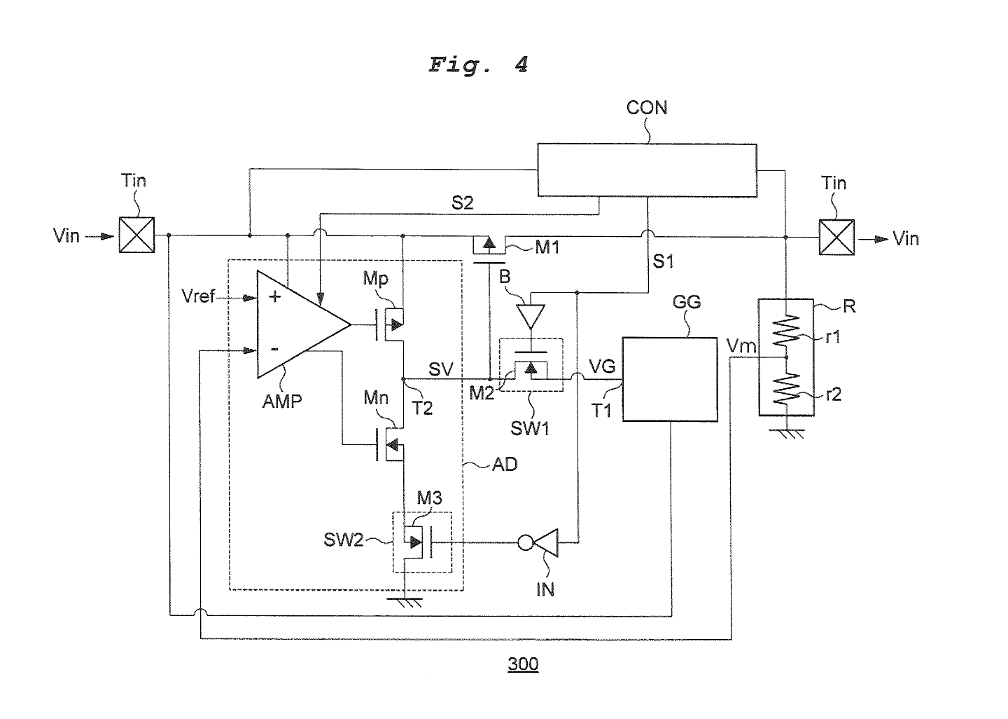

FIG. 4 is a circuit diagram of a semiconductor integrated circuit 300 according to the third embodiment. The same legend is used in FIG. 4 as in FIG. 1 to identify the same components.

As shown in FIG. 4, similar to that of the first embodiment, the semiconductor integrated circuit 300 includes a main MOS transistor(p-MOS transistor) M1, a sub-voltage circuit R, a gate voltage generating circuit GG, a first switch element SW1, a buffer B, an inverter IN, an amplifying device AD and a control circuit CON.

When the potential difference between the power voltage Vin (over 1.8 V, for example) and the output voltage Vout (1.2 V, for example) is higher than the second specified value (0.6 V, for example), the control circuit CON determines that the power voltage Vin is a voltage higher than the first specified value (1.8 V, for example).

On the other hand, when the potential difference is lower than the second specified value (0.6 V, for example), it can be determined that the power voltage Vin is a voltage lower than the first specified value (1.8 V, for example).

In this way, the control circuit CON executes a control operation on the basis of the potential difference between the power voltage and the output voltage.

The other structure and functions of the semiconductor integrated circuit 300 of the third embodiment is the same as that of the first embodiment.

The semiconductor integrated circuit according to the third embodiment can also be used as either a series regulator or a power switch according to the power voltage.

### Fourth Embodiment

The fourth embodiment employs a control circuit that controls based on the potential difference between a power voltage and an output voltage.

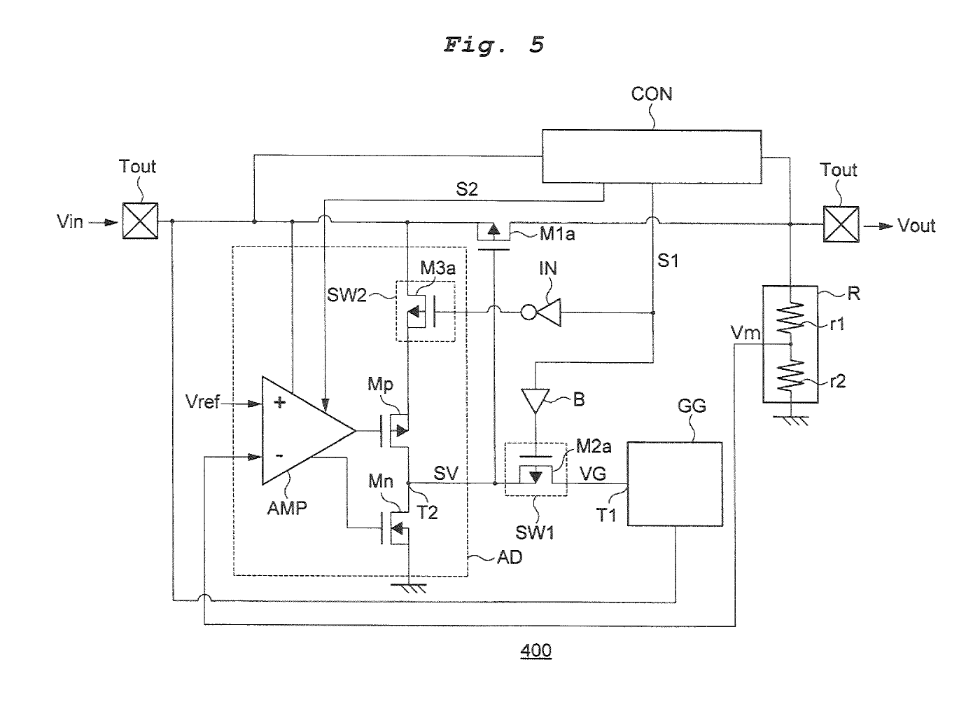

FIG. 5 is a circuit diagram showing a semiconductor integrated circuit 400 according to the fourth embodiment. The same legend is used in FIG. 5 as in FIG. 3 to identify the same components.

As shown in FIG. 5, the semiconductor integrated circuit 400 includes a main MOS transistor(n-MOS transistor) M1a, a sub-voltage circuit R, a gate voltage generating circuit GG, a first switch element SW1, a buffer B, an inverter IN, an amplifying device AD and a control circuit CON.

When the potential difference between the power voltage Vin (over 1.8 V, for example) and the output voltage Vout (1.2 V, for example) is higher than the second specified value (0.6 V, for example), the control circuit CON determines that the power voltage Vin is a voltage higher than the first specified value (1.8 V, for example).

On the other hand, when the potential difference is lower than the second specified value (0.6 V, for example), the control circuit CON determines that the power voltage Vin is a voltage lower than the first specified value (1.8 V, for example).

In this way, the control circuit CON executes a control operation on the basis of the potential difference between the power voltage and the output voltage.

The other structure and functions of the semiconductor integrated circuit 400 in the fourth embodiment are the same as that of the second embodiment.

The semiconductor integrated circuit according to the fourth embodiment can be used as either a series regulator or a power switch according to the power voltage.

Additionally, the embodiments described above should not restrict the scope of actual invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying Claims and their equivalents are intended to cover such forms or modifications as would fall within the scope and spirit of the inventions.

What is claimed is:

1. A semiconductor integrated circuit comprising:
a main MOS transistor connected between an input power terminal to which a power voltage is applied and an output power terminal configured to output an output voltage;
a gate voltage generating circuit configured to output a gate voltage to turn on the main MOS transistor; and
an amplifying device configured to output a control voltage according to a comparison between a monitoring voltage corresponding to the output voltage and a reference voltage,
wherein, when the power voltage is higher than a first specified value, the amplifying device is activated to regulate the monitoring voltage to a value equal to the reference voltage so that the control voltage is applied to a gate of the main MOS transistor, and
wherein, when the power voltage is lower than the first specified value, the amplifying device is deactivated so that the gate voltage is applied to the gate of the main MOS transistor.

2. The semiconductor integrated circuit according to claim 1, further comprising:
a first switch element connected between the gate of the main MOS transistor and an output of the gate voltage generating circuit,
wherein, when the power voltage is higher than the first specified value, the first switch element turns off, and
wherein, when the power voltage is lower than the first specified value, the first switch element turns on.

3. The semiconductor integrated circuit according to claim 2, wherein, when the power voltage is lower than the first specified value, the output of the amplifying device is changed to have a higher impedance.

4. The semiconductor integrated circuit according to claim 2, further comprising:
a control circuit configured to control the first switch element and the amplifying device according to the power voltage,
wherein, when the power voltage is higher than the first specified value, the control circuit generates a control signal to activate the amplifying device and turn off the first switch element, and
wherein, when the power voltage is lower than the first specified value, the control circuit generates a control signal to deactivate the amplifying device and turn on the first switch element.

5. The semiconductor integrated circuit according to claim 2, wherein the main MOS transistor is a p-MOS transistor in which a source and a back gate are connected to the input power terminal and a drain is connected to the output power terminal.

6. The semiconductor integrated circuit according to claim 5, wherein the gate voltage generating circuit includes a circuit for generating a negative voltage, and applies an output of the circuit for generating the negative voltage to a gate of the main MOS transistor.

7. The semiconductor integrated circuit according to claim 2, wherein the main MOS transistor is an n-MOS transistor in which a drain is connected to the input power terminal and a source and a back gate are connected to the output power terminal.

8. The semiconductor integrated circuit according to claim 7, wherein the gate voltage generating circuit comprises a circuit for generating a positive voltage, and applies an output of the circuit for generating the positive voltage to a gate of the main MOS transistor.

9. A semiconductor integrated circuit comprising:
a transistor connected between an input power terminal and an output power terminal;
a voltage generating circuit configured to output a gate voltage to turn on the transistor;
a switch element connected between a gate of the transistor and an output of the voltage generating circuit;
an amplifying device configured to output a control voltage according to a comparison between a monitoring voltage corresponding to an output voltage at the output power terminal and a reference voltage; and
a control circuit configured to control the switch element and the amplifying device such that, when a voltage at the input power terminal is higher than a predetermined value, the control voltage is applied to the gate of the transistor and, when the voltage at the input power terminal is lower than the predetermined value, the gate voltage is applied to the gate of the transistor.

10. The semiconductor integrated circuit according to claim 9, wherein, when the voltage at the input power terminal is higher than the predetermined value, the switch element turns off and, when the voltage at the input power terminal is lower than the predetermined value, the switch element turns on.

11. The semiconductor integrated circuit according to claim 10, wherein, when the voltage at the input power terminal is lower than the predetermined value, the output of the amplifying device is changed to have a higher impedance.

12. The semiconductor integrated circuit according to claim 9, wherein the transistor is a p-MOS transistor in which a source and a back gate are connected to the input power terminal and a drain is connected to the output power terminal.

13. The semiconductor integrated circuit according to claim 12, wherein the voltage generating circuit includes a circuit for generating a negative voltage, and applies an output of the circuit for generating the negative voltage to the gate of the p-MOS transistor.

14. The semiconductor integrated circuit according to claim 9, wherein the transistor is an n-MOS transistor in which a drain is connected to the input power terminal and a source and a back gate are connected to the output power terminal.

15. The semiconductor integrated circuit according to claim 14, wherein the voltage generating circuit comprises a circuit for generating a positive voltage, and applies an output of the circuit for generating the positive voltage to a gate of the n-MOS transistor.

16. A method of operating a semiconductor integrated circuit as either a series regulator or a power switch, the semiconductor integrated circuit including a transistor connected between an input power terminal and an output power terminal, a voltage generating circuit configured to output a gate voltage to turn on the transistor, a switch element connected between a gate of the transistor and an output of the voltage generating circuit, an amplifying device configured to output a control voltage according to a comparison between a monitoring voltage corresponding to an output voltage at the output power terminal and a set reference voltage, and a control circuit configured to control the switch element and the amplifying device, said method comprising:
when a voltage at the input power terminal is higher than a predetermined value, applying the control voltage to the gate of the transistor; and
when the voltage at the input power terminal is lower than the predetermined value, applying the gate voltage to the gate of the transistor.

17. The method of claim 16, further comprising:
when the voltage at the input power terminal is higher than the predetermined value, turning the switch element off; and
when the voltage at the input power terminal is lower than the predetermined value, turning the switch element on.

18. The method according to claim 16, further comprising:
when the voltage at the input power terminal is lower than the predetermined value, increasing an impedance at the output of the amplifying device.

19. The method according to claim 16, further comprising:
generating a negative voltage by the voltage generating circuit; and
applying the negative voltage to the gate of the p-MOS transistor.

20. The method according to claim 16, further comprising:
generating a positive voltage by the voltage generating circuit; and
applying the positive voltage to the gate of the p-MOS transistor.
